(19) United States
(12) Patent Application Publication
(10) Pub. No.: US 2015/0006357 A1
(43) Pub. Date: Jan. 1, 2015

(54) Systems and Methods for Early Fair Lending Violation Detection

(71) Applicants: Brian Kenneth Perry, Frisco, TX (US); Ivan Henri Darius, Frisco, TX (US)

(72) Inventors: Brian Kenneth Perry, Frisco, TX (US); Ivan Henri Darius, Frisco, TX (US)

(21) Appl. No.: 14/294,282

(22) Filed: Jun. 3, 2014

Related U.S. Application Data
(60) Provisional application No. 61/830,396, filed on Jun. 3, 2013.

(51) Int. Cl. G06Q 40/02

(52) U.S. Cl. CPC G06Q 40/025
USPC 705/38

(57) ABSTRACT

As long as mortgage lenders allow some degree of flexibility in their loan pricing, strong fair lending controls are required to avoid/defend against discrimination claims, whether intentional or inadvertent “disparate impact.” Pricing engine technology combined with the process and methodology can help lenders to efficiently reduce the risk of fair lending compliance issues. Pricing engines can help a lender lock down pricing, enforce limits on discretionary adjustments, enforce/document approval authority for granting concessions or exceptions, limit the potential for errors, and provide the data/documentation needed to respond effectively to regulatory inquiries. Further, pricing engine technology can facilitate real-time monitoring for potential pricing disparities, and serve as the basis for an “early-warning” system that flags pricing disparities as they develop. The current regulatory climate demands that mortgage lenders place greater reliance on up-front fair lending preventive controls, rather than waiting to identify fair lending issues only after they have occurred.

### CROSS REFERENCE TO RELATED APPLICATION

This application claims the benefit under 35 U.S.C. §119(e) of U.S. Provisional Patent Application Ser. No. 61/830,396 filed on Jun. 3, 2013, entitled “Systems and Methods for Early Fair Lending Violation Detection,” which is incorporated by reference in its entirety.

### FIELD OF THE DISCLOSURE

The present disclosure generally relates to early detection of potential fair lending issues, and more particularly to use of an as-of-right-now pricing engine with access to historical prices and eligibility rules and a set of normalization, alarming and notification techniques.

### BACKGROUND

Fair lending continues to be a major enforcement priority of federal agencies, and numerous pricing-related fair lending enforcement actions have been taken by the U.S. Department of Justice (“DOJ”) in recent years. The Consumer Financial Protection Bureau (“CFPB”) has also made fair lending examination and enforcement a top priority. It is clear from the DOJ's and CFPB's public enforcement actions and pronouncements that a major focus of fair lending concern with respect to mortgage loan pricing has been discretionary pricing adjustments. In most of the recent pricing-related fair lending settlements reached by the DOJ, the government has alleged that lender policies or practices of allowing loan originators to make discretionary pricing adjustments had a discriminatory “disparate impact” that resulted in minority borrowers being charged more for a mortgage loan than similarly qualified non-Hispanic white borrowers. Under the disparate impact theory of discrimination, a lender's facially neutral policies or practices could be found to have a “discriminatory effect” if statistical analysis shows that they have a disproportionate adverse impact on a prohibited basis, unless the policies or practices can be shown to have a legitimate business justification. The loan originator compensation rules under Regulation Z that were implemented in April 2011 have helped to reduce fair lending risk in pricing, but they have not eliminated it. Pricing discretion can result in fair lending risk even if loan originators are not compensated based on terms and conditions of a loan, and even if there is no intent to discriminate, regardless of who in the organization has the authority to make discretionary pricing adjustments. Many mortgage lenders find it necessary to permit some degree of discretionary pricing concessions for such purposes as meeting a competitor's rate quote, rewarding customer loyalty, addressing customer service issues, or filling mandatory commitments. In addition, though it is increasingly uncommon for lenders to allow “up-charging” relative to posted rates, pricing premiums (or “overages”) can occur as a result of granting the borrower the lowest available rate that does not require the borrower paying discount points. In such situations, there may be room for discretion in the use of the premium revenue that is generated—i.e., discretion in granting credits to cover closing costs. Such discretion is not inherently bad or illegal, but it does elevate the lender's fair lending regulatory risk exposure. If the exercise of discretion has the effect favoring one protected demographic group over another, whether that was intentional or not, enforcement agencies may regard it as illegal discrimination. Other factors consistently cited by the DOJ in recent fair lending settlements as contributing to alleged pricing discrimination have included a lack of clear policies and controls governing the exercise of discretion, a lack of documented business rationale for discretionary pricing adjustments, and a lack of effective fair lending monitoring and corrective action. These problems can be exacerbated by a lack of complete and accurate data that is required to examine and explain pricing disparities, which may appear in the aggregated loan data typically relied upon by regulatory examiners. Even putting aside the effects of discretion, statistical pricing disparities can arise if a lender's branches or originators have different pricing levels or fees and sell into the same markets. Similarly, disparities can arise if the branches or originators serving markets with high minority concentrations tend to have higher pricing levels or fees than branches serving markets with low minority concentrations. Controlling fair lending compliance risk in the face of regulatory concerns and market realities can be costly and cumbersome unless technology tools are exploited to automate the necessary preventive controls.

### SUMMARY

Embodiments of the present disclosure may provide a system for early fair lending violation detection, the system comprising: a computerized mechanism that may compute the price-rate-function for one or more mortgage products over a specified lock period; one or more WebBots, wherein, under the control of a scheduler-coordinator module, the one or more WebBots may navigate websites to retrieve pricing and eligibility of mortgage products offered by outlets; a price extraction module that may interpret the pricing and eligibility of the mortgage products offered by outlets to form and then load price-rate grids into the product and pricing engine; and a lock intercept module that may use the price-rate-function computed by the computerized mechanism to identify one or more actions to be taken, wherein the computerized mechanism, the one or more WebBots, the price extraction module, and the lock intercept module may communicate with each other over one or more communication networks. The computerized mechanism may be a product and pricing engine or a Bloomberg terminal according to some embodiments of the present disclosure; however, other computerized mechanisms may be utilized without departing from the present disclosure. One of the one or more WebBots may download government-published APOR data. The one or more actions to be taken by the lock intercept module may be selected from the group comprising: trigger the addition of a question to a compliance checklist to be answered before a lock request can be completed; set flag to temporarily halt a lock request and add it to an exception queue for further processing; set flag to temporarily halt the lock request and add it to an exception queue for escalation; set flag to temporarily halt the lock request and add it to an exception queue for escalation and sign off; set flag to temporarily halt the lock request and add it to an exception queue for sign off; deny the lock request; and set flags used by an alarm module to provide an alert that a lock request is out of spec. The system may further comprise a user interface module that may communicate a resulting workflow to a loan officer. The resulting workflow may be selected from the group comprising: lock accepted, lock accepted with extra information, lock subject to approval, lock subject to approval through escalation, and lock denied. The one or more communication networks may be selected from the group comprising: Internet, Intranet, radio frequency, Bluetooth, infrared, USB, LAN, wireless LAN (WiLAN), worldwide interoperability for microwave access (WiMAX), WiFi, ultra-wide band (UWB), Wibree techniques, wide band code division multiple access (W-CDMA), CDMA2000, global system for mobile communications (GSM), general packet radio service (GPRS), long term evolution (LTE), WLAN, WiMAX, digital subscriber line (DSL), cable modems, Ethernet, and combinations of the same.

Other embodiments of the present disclosure may provide a method for processing a loan intercept with a lock intercept module, the method comprising: receiving an alert of a pending lock request; and processing the loan intercept by using a loan profile and selected product information provided by a product and pricing engine over a communication link to determine actions to be taken, wherein the actions to be taken are selected from the group comprising: triggering the addition of a question to a compliance checklist to be answered before a lock request can be completed; setting a flag to temporarily halt a lock request and add it to an exception queue for further processing; setting flag to temporarily halt the lock request and add it to an exception queue for escalation; setting flag to temporarily halt the lock request and add it to an exception queue for escalation and sign off; setting flag to temporarily halt the lock request and add it to an exception queue for sign off; denying the lock request; and setting one or more flags to be used by an alarm module to provide an alert that a lock request is out of spec, wherein the steps are performed using one or more communication networks. Processing the loan intercept may further comprise calculating the relative equivalent distance to APOR (RED) using the equivalent rate and the equivalent APR based on engine-generated profile-based loan-level price adjustments and a selected rate/price. Processing the loan intercept also may comprise using a set of predefined and user-defined filters to identify to what filter the lock request belongs; and using the identified filter, comparing the RED to an aggregated RED for the identified filter. The predefined and user-defined filters may be a combination of loan product, geographic, borrower and property parameters used to group loans with similar rate/price outcomes when fed with equivalent profiles. Further, when the loan profile includes ethnicity, the method may include comparing the RED to ethnicity-based aggregates. In addition, when the action to be taken is triggering the addition of a question to a compliance checklist to be answered before a lock request can be completed, the method may further comprise storing the answer to the question with the loan information for later reporting. The method also may comprise after processing, communicating a resulting workflow to a loan officer. The resulting workflow may be selected from the group comprising: lock accepted, lock accepted with extra information, lock subject to approval, lock subject to approval through escalation, and lock denied. The one or more communication networks may be selected from the group comprising: Internet, Intranet, radio frequency, Bluetooth, infrared, USB, LAN, wireless LAN (WiLAN), worldwide interoperability for microwave access (WiMAX), WiFi, ultra-wide band (UWB), Wibree techniques, wide band code division multiple access (W-CDMA), CDMA2000, global system for mobile communications (GSM), general packet radio service (GPRS), long term evolution (LTE), WLAN, WiMAX, digital subscriber line (DSL), cable modems, Ethernet, and combinations of the same.

Further embodiments of the present disclosure may provide a method for early detection of fair lending violations, the method comprising: utilizing a lock intercept module, performing a lock intercept process to compute whether a requested lock is acceptable to a lender using the desired/existing equivalent for a group and at least one parameter selected from the group comprising: relative distance to APOR, relative equivalent distance to APOR, quoted rate, price and APR; using the output of the lock intercept process to perform one of the following actions: continue the automated lock process, interrupt the process by requiring further disclosure and explanation of the borrower/loan officer reached decisions; and interrupt the process by putting the lock in a hold queue for approval by one or more levels of compliance managers; and using the output of the lock intercept process to produce a notification about the current state of compliance, wherein the notification may be provided over one or more communication networks. The notification may be a visual or auditory alert. The notification may be performed by an alarm module.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 depicts a lock intercept process according to an embodiment of the present disclosure;

FIG. 2 depicts obtaining lock continuation data according to an embodiment of the present disclosure;

FIG. 3 depicts a typical price versus rate dependency for a given product and lock period according to an embodiment of the present disclosure; and

FIG. 4 depicts how, under the coordination of the scheduler-coordinator module, the WebBots may start navigating the World Wide Web (i.e., Internet) and check the web sites they are assigned according to an embodiment of the present disclosure.

### DETAILED DESCRIPTION

In the mortgage space, loans are priced based on a couple of principles. The first one is that the “rate” (interest rate) is determined by a set of elements, including but not limited to: the current and/or future price of Mortgage Backed Securities (MBS); the risk-profile of the borrower; the risk/value profile of the property backing the loan; the competitive retail landscape; the propensity of the borrower to “buy down” the interest rate of the loan; and the time the borrower wants to “lock in” the interest rate being offered. The result is that in the typical transaction the loan is priced off a “pricing grid” where the price of a loan is listed as a function of both the interest rate and the lock period. The “price” of a loan is a concept that is somewhat unique to the residential mortgage industry; the basic principle is that one can “buy” a loan of a certain interest rate at certain “price”. Usually that price is expressed in “origination points” or percentage points of the loan amount. Convention dictates that when the “price” is equal to 100, the loan is considered at “par.” The price carries the following connotation: if the price is 100 (par), then it means the borrower is not paying any “origination points;” if it is below 100, the borrower is buying the interest rate down; if the price is above 100, the borrower is getting a rebate (cash-back) which can be used to offset closing costs or towards a down payment. The eventual rate and the corresponding price is the result of the borrower and the loan officer or mortgage broker selecting the appropriate rate-price combination.

Anti-discrimination legislation and regulations have been in force for several years making it illegal to steer minorities and protected classes towards higher cost (rate) loans.

Currently the lenders are required to produce certain information about their loans to the proper government agencies, which then use this information to determine if the lender violated any of the regulations or laws. Many lenders use reporting packages that analyze the data before it is sent to the agency so possible issues can be identified. The problem with this approach is that it is largely an “after the fact” analysis; the problems that are detected will have to be corrected by potentially lowering the rates of certain borrowers to eliminate perceived or actual bias. This can be very costly to the lenders.

The most common workflow used by loan officers and/or brokers when called by potential clients, about to become borrowers, is to go through the high level parameters of the potential transaction (the transaction being a loan, said loan being a combination of a borrower, a property and a loan product or program), propose a potential loan product and after agreement of terms, “lock” in the salient loan product parameters (including but not limited to type of loan, term, rate, and lock period). This “lock” is a promise by the lender to honor the values of the mentioned parameters for the a time equal to the lock period if the information the borrower has given about the property and their financial situation is accurate.

Since there are a significant number of pieces of information disclosed or discovered about both the borrower's financial (credit) situation, the property and the timing, the lender is taking a certain amount of risk when “locking” the loan; the quid pro quo is the, at least, perceived notion that a “locked” customer will stop shopping around for different offers.

For most loans that are locked, the information on which the lock was based changes during the life of the lock (life of the lock is the time between the lock and the closing (or cancelling) of the loan transaction). These changes may or may not influence the rate and price originally locked, but, for obvious reasons, the lenders will try to hold the originally negotiated price for fear that the borrower will walk if the price is significantly changed. So, a lot of loans will close (transaction completed) at the rate they were locked at, in any case, there will be a very strong correlation between the rate at which the loan was locked and the rate at which it will close.

Recently the Consumer Financial Protection Bureau (CFPB) has been focused heavily on the issue of Fair Lending. The definition of Fair Lending has not been completely and formally established but generally centers on lenders not showing a significant difference in the cost (rate or APR) of loans to people of different ethnicities and part of protected classes. Bias is often claimed when the average rates for protected classes differ from the average rates for the control group.

In embodiments of the present disclosure, a loan officer or broker may be stopped from locking a borrower into a rate, at the time of the lock request, which would cause a problematic rate-ethnicity/race profile for the lender.

Depending on the workflow decisions the lender's management makes, the acceptance or rejection of the lock request can be automatic or manual. Embodiments of the present disclosure may provide the Lock Acceptance/Rejection Decision process with the necessary information for the early detection of potential Fair Lending or Disparate Impact violations.

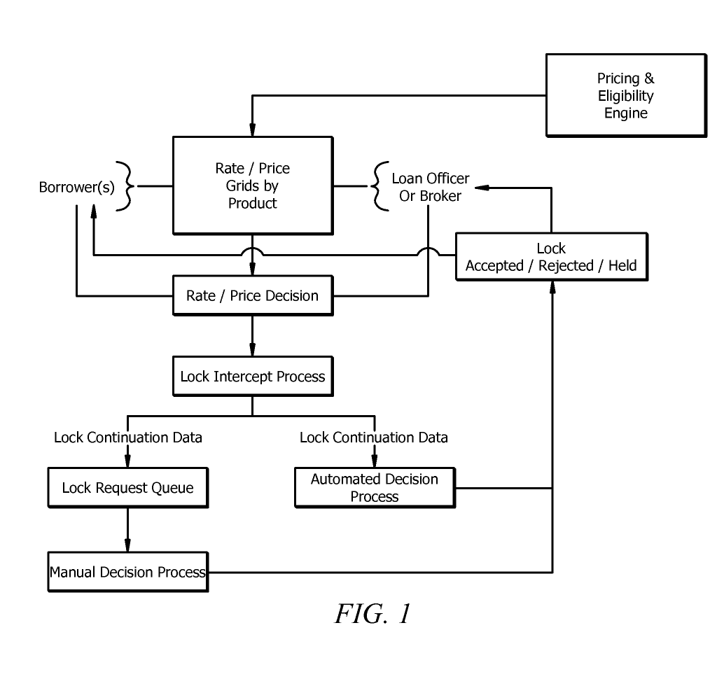

In order to be able to warn the lender of potential Fair Lending issues, a couple of things need to be in place. Embodiments of the present disclosure do exactly that. When a borrower contacts a broker or a lender's loan officer to discuss the potential purchase or re-financing of a home they usually do that to check whether they will qualify for a lender's offering and if so, at what cost to them. The parameters exchanged by the parties are used to determine eligibility (i.e., whether the borrower/property profile fit a lender's product criteria) and to calculate the price. At that point a “lock request” is made to the lender's lock desk. This is illustrated in FIG. 1, which describes a “lock intercept process” according to an embodiment of the present disclosure.

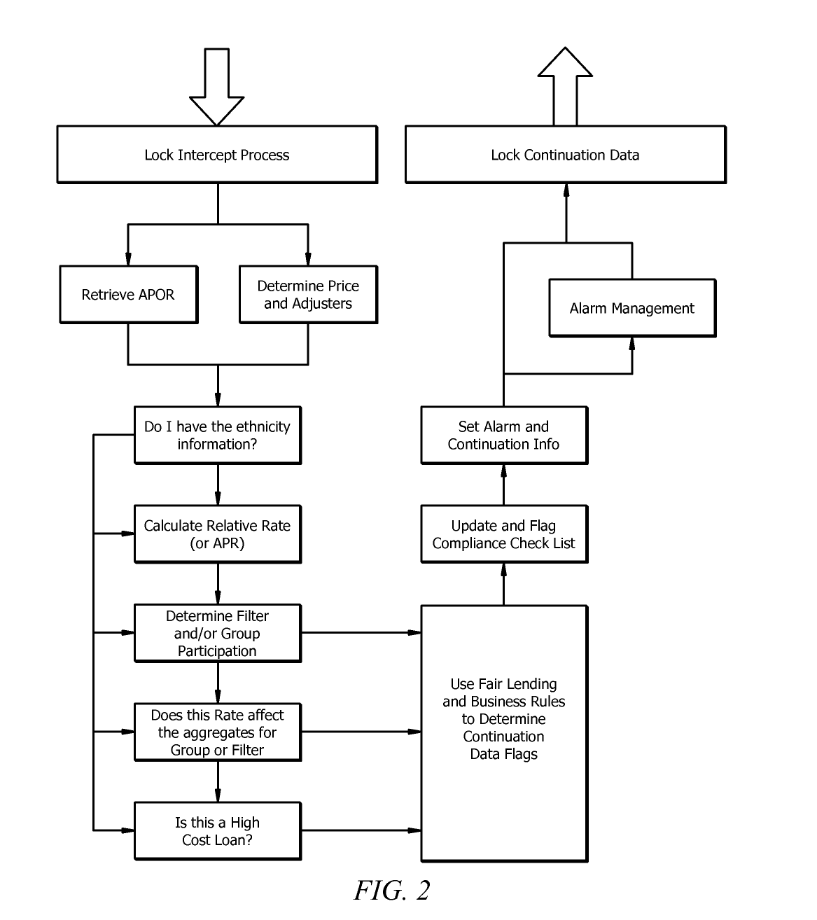

The result of the “lock intercept process” is “lock continuation data” which may be obtained according to an embodiment of the present disclosure as depicted in FIG. 2.

The decisions with the lock intercept process may be made based on a set of data points collected by the system, the borrower/property profile, current market conditions and a set of business rules designed to make sure the rate/price combination presented for “lock” is appropriate according to embodiments of the present disclosure. One of the things considered, and embodiments of the present disclosure may provide, a way to normalize the rate for a given loan so that it can be compared to the rates of other loans being presented for “lock” within the same geographic area (market) and within the different borrower groups.

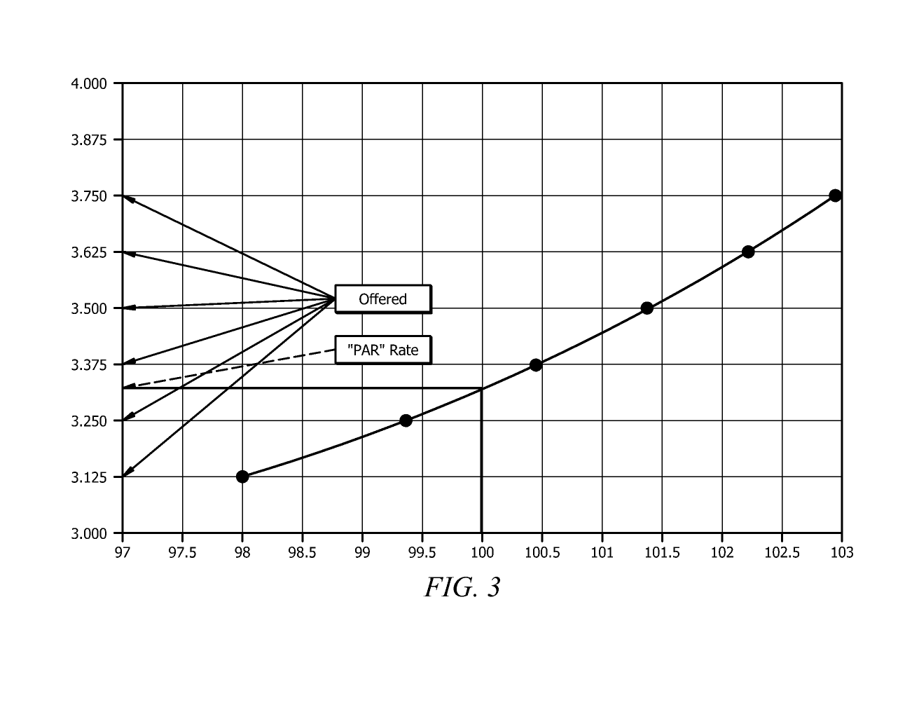

As mentioned earlier, a “price” of a loan is usually communicated using a “pricing grid” where the price of a loan is listed as a function of both the interest rate and the lock period. For a particular lock period, in an embodiment of the present disclosure, the grid may be graphically represented as depicted in FIG. 3. Highlighted are: the “offered rates” (the rates normally offered by lenders to borrowers are typically rates in increments of ⅛^{th} of a percentage point, and range typically form a couple of percentage points below “PAR” to a couple of points above “PAR”); and the “PAR rate,” typically the rate at which the borrower is not charged any origination points, or in lender jargon the “price” of the interest rate is 100 or PAR. However, it should be appreciated that there may be other embodiments of the present disclosure wherein the PAR may be 0, usually referred to as zero-based pricing.

FIG. 3 depicts a typical price versus rate dependency for a given product and lock period. As can be seen in FIG. 3, the actual “PAR” rate is not being offered (since it is not a ⅛th increment). Accordingly, any rate offered would either have a price less than (borrower pays origination points) 100 or greater than (borrower would receive a rebate towards closing costs) 100. What rate eventually gets picked by the borrower in discussion with the loan officer/broker may depend on whether the borrower has funds to cover origination points in which case he will receive a lower rate, or needs the lender to cover some of the closing costs, in which case the borrower will receive a higher rate. Whatever the choice of the borrower is, the rate offered in both cases would have been a rate adjusted by the effect of the choice.

FIG. 3 depicts that the relationship between rates and prices can been approximated by the blue line shown. These adjustments can be computed by following “along” the blue line depicted in FIG. 3 (effectively translating a price difference into a rate difference). A certain functional dependency may be postulated as:

2
2. The function f Price may be called the Price-Rate-function (PRF). The PRF may then be used to adjust the quoted rate for the choices of the borrower; resulting in what may be called the equivalent rate.

| | Quoted | | | | Equivalent |
|---|---|---|---|---|---|
| Borrower | Rate | Loan Price | Price Delta | Rate Delta | Rate |
| Borrower 1 | 3.250 | 99.371 | 0.629 | 0.0739 | 3.324 |
| Borrower 2 | 3.375 | 100.430 | −0.430 | −0.0505 | 3.324 |

The discussion thus far has addressed the “base rate-price dependency”; however, risk-based pricing also may be taken into account according to embodiments of the present disclosure. Risk-based pricing may be expressed as an adjustment to the “base price.” In general, these adjustments may be based on the borrower's and the property's profile and the loan-to-value ratio (LTV) of the loan. Borrowers with lower FICO (credit) scores may be considered a higher risk, and, combined with higher LTV values, can considerably change the base price a borrower would pay for a certain interest rate. Some lenders have low base pricing and add cost for higher risk loans; some have higher base pricing and reward lower risk loans with reduced costs.

In any case, borrower-property-loan trios with the same risk profiles will get the same adjustments to the price. Similarly, borrower-property-loan trios with different risk profiles will get different adjustments to the price and consequently potentially a different rate. The rate offered may be “equalized” by (virtually) adjusting the rate using the PRF with the adjustments.

Similar to the analysis previously described, if there is access to a mortgage-pricing engine, the price difference may be translated into a rate difference and the equivalent rate for two different scenarios may be calculated as shown below:

| | | | | Total | | Equiv- |
|---|---|---|---|---|---|---|
| | Quoted | Adjust- | Loan | Price | Rate | alent |
| Scenario | Rate | ment | Price | Delta | Delta | Rate |
| Scenario 1 | 3.250 | 0.0 | 99.371 | 0.629 | 0.0739 | 3.324 |
| Scenario 2 | 3.500 | −1.500 | 99.873 | −1.373 | −0.1613 | 3.339 |

Using these calculations, it may be possible to determine, by evaluating the rates quoted for borrowers 1 and 2 and/or in scenarios 1 and 2, whether the quoted rate differences were “in line”, and that would be the case if the equivalent rates are close or the same.

These calculations are accounting for the inherent rate bias introduced by the borrower choices and the loan's risk profile for a certain loan product. Different loan products will have different PAR rates and different PRFs. In addition, the lock period, usually defined as the time that the lender will guarantee the “locked” rate to the borrower for the same price, will influence the price of a rate. In general, the longer-to-lock period, the more expensive the same rate becomes. This can be adjusted for relatively easily given that the rate-price curve for different lock periods are (in a first order approximation) translations (shifts along the x-axis) of each other. Provided there are means to discriminate between different loan products (fixed versus ARM, 30 Year versus 15 Year terms, etc.), the above should give a context and methodology compare two (or more) lock requests that are being generated during the lender's process.

Since most lenders do not originate a massive amount of loans per unit of time, and most lenders will originate up to a couple of 100 lock requests per month, lock requests (rates) often may be compared that originated with significant time differences between them. Since the prices for the rates of the loans fluctuate with a frequency of a couple of hours typically (in a highly volatile market most lenders will price 2 or 3 times per day) and the lock requests to be compared may be further apart than that (typically days), a mechanism may be provided for eliminating what may be referred to as the time or market bias.

One methodology is to use a government-supplied index called APOR (Average Prime Offer Rate). The APOR is published weekly by the government and essentially sets (for determining High Price Loans) what the rate “offered in the market” is for fixed and ARM loans by the loans terms (from 1 to 40 years). Since this index is time-dependent, it can be used to eliminate the obvious time difference effect in locks by using the difference between the equivalent rate (or APR) and the APOR. This may be referred to as the Relative Distance to APOR (RΔ) or Relative Equivalent Distance to APOR (RED). This RΔ can now be used to determine whether a new lock is within a certain spread of the desired current averages within a predefined group of loans. These groups are essentially defined along product characteristics'lines and along ethnicity and race lines as depicted below:

| | Ethnicity-Race | | |
|---|---|---|---|
| Product | Control Group | Protected Class 1 | Protected Class N |
| Purchase | RΔ(RED) = 0.754 | RΔ(RED) = 0.853 | RΔ(RED) = 0.691 |
| Conforming | | | |
| 30 Year Fixed | | | |
| Purchase | RΔ(RED) = 0.350 | RΔ(RED) = 0.294 | RΔ(RED) = 0.491 |
| Conforming | | | |
| 15 Year Fixed | | | |
| REFI | RΔ(RED) = 0.855 | RΔ(RED) = 0.879 | RΔ(RED) = 1.001 |
| Conforming | | | |
| 30 Year Fixed | | | |
| . . . | | | |

The spread around APOR varies by product and geographically but is generally situated between −0.500% and 1.500%.

The lock interrupt process module can now proceed and compute whether a requested lock (rate, price pair) is acceptable to the lender based on its RΔ (or any other parameter, Quoted Rate, Price, APR, etc.) and the desired/existing equivalent for the group. The output of this process may then be used to either continue the automated lock process, interrupt the process by either requiring further disclosure and explanation of the borrower/loan officer reached decisions or putting the lock in a hold queue for approval by one or more levels of compliance managers. In addition, the data can be used by an alarm module that for loan groups, business channels or individual loan officers may produce visual or auditory clues about the current state of compliance for these collections.

What is currently referred to as a product and pricing engine is a collection of software applications and storage mechanisms (usually databases managed by RDBMS (Relational Data Base Management Systems)). The product and pricing engine may contain the loan product definitions, the eligibility rules, the risk based adjustments (rules), the originator's (lender's) margins and the current pricing grids. Depending on the implementation, the loan information can be retrieved by presenting a “profile” (a set of parameter values describing the borrower's financial situation and the property's location and cost) to the product and pricing engine either by calling an embedded software module or, in more contemporary implementations by calling a web service that has access to the product and pricing engine functionality. The result is most likely a set of eligible products with corresponding rate-price grids. Within the context of an existing product and pricing engine, the modules implementing this disclosure may interact as follows.

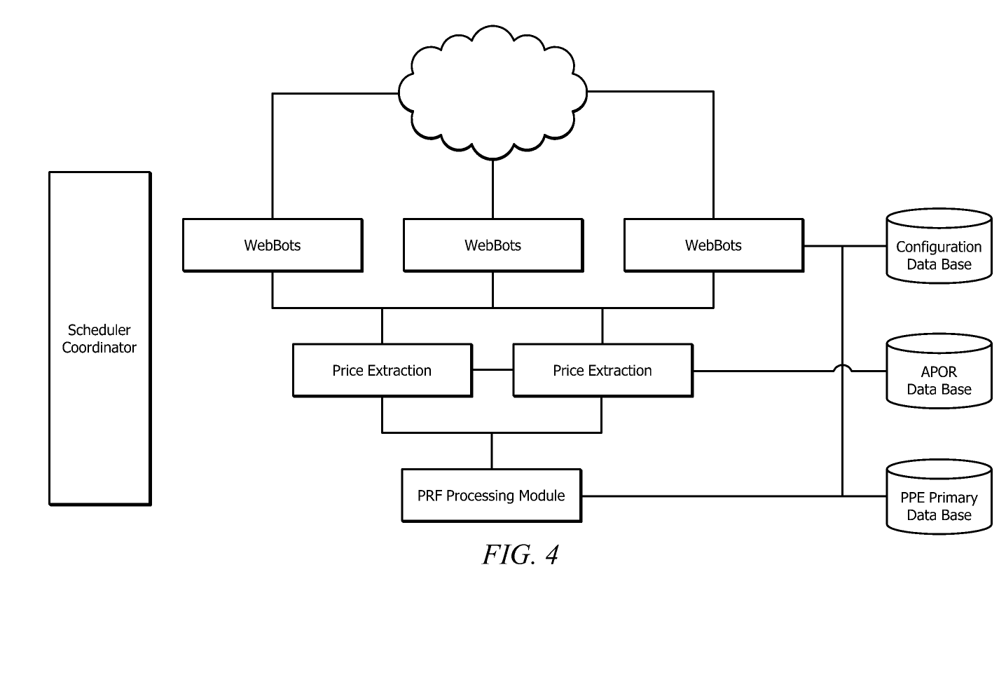

In order to keep the content of a product and pricing engine current and relevant at all times the product and pricing engine may gather data and process it into usable form. WebBots are browser-emulating software applications that are use to navigate to specific web sites for the retrieval of pricing and eligibility of mortgage products offered by the outlets (aggregators or GSEs (Fannie, Freddie etc.)). Under the coordination of the scheduler-coordinator module, the WebBots may start navigating the World Wide Web (i.e., Internet) and check the web sites they are assigned as depicted in FIG. 4.

After the WebBot has determined that the content of the web site it has been assigned has changed in a relevant way (new pricing has been posted), the WebBot may download the appropriate content and passes it to a price extraction module. This module may use the configuration store to interpret the downloaded information and load the price-rate grids in the product and pricing engine primary store for use by the product and pricing engine modules according to embodiments of the present disclosure. The price-rate grids may be stored by product. A product in this context may be defined as set of guidelines, definitions and price-rate grids, which when a single rate-price combination is picked and combined with a borrower and a property, is called a loan. One of the WebBots may be assigned the task of downloading the government-published APOR data from the official website, which may then be stored so it can be retrieved.

When the loading is completed, this may trigger the start of the PRF processing 2 of the function f Price for every product for the 30-day lock period. Using the least-squares 2, to check the quality of the fit and it may eliminate outliers until the R² value exceeds a 2) may be stored for every product that can be returned by the product and pricing engine. The above process may happen asynchronously and independent from the loan officer's (lender's) interaction with the product and pricing engine according to embodiments of the present disclosure.

The workflow elements that are the subject of this disclosure may come into play when the loan officer has finished the preliminary discussion with the borrower (or when through some other means such as a consumer-facing website) a lock is requested. The lock intercept module may be made aware of the “pending lock request” and may use the selected product information (provided by the product and pricing engine) and the Loan Profile (provided to the product and pricing engine) to process the intercept.

The lock intercept module may now run the following set of procedures:
Retrieve the APOR for the loan term and type from the APOR database;
Calculate the RΔ from that and the APR; 2,) to calculate the RED using the equivalent rate and the equivalent APR based on the engine-generated profile-based loan-level price adjustments (LLPAs) and chosen rate/price combination;
Use a set of stored “filter” characteristics to determine what filter the current request belongs to. The system according to an embodiment of the present disclosure may maintain a set of pre-defined and user-defined “filters.” The filters may be a group of loan product, geographic, borrower and property parameters that may be used to group loans that should have similar if not identical rate/price outcomes when fed with equivalent profiles. The system may maintain these filters by lender and user. Aggregate values for all “measured” values (rate, RΔ, RED, APOR, LTV, Loan amount etc.) may be maintained and stored by the system modules.
For that filter (or whatever group of filters this request belongs to), the RΔ and RED may then be compared to the aggregated (averages, Max and Min) RΔs and REDs for these filters. If the ethnicity is included in the profile, then the request's values for RΔ and RED may be compared to the ethnicity-based aggregates.
The lock intercept module may now run a set of database-stored and lender-specific rules to determine the actions to be taken by the module (in auto mode) or by the secondary marketing manager or compliance person using the system (in manual mode). The actions may include (but are not limited to):
   Trigger the addition of a question to the compliance checklist. During the lock request process in the system, the loan officer (or broker) may be presented with a configurable list of questions that need to be answered by the loan officer or broker before the lock request can be completed. The system may store the answers to these questions with the loan for later reporting;
   Set flag to temporarily halt the request and add it to an exception queue for further processing;
   Deny the request altogether; and/or
   Set flags that can be used by the optional alarm module to alert operations that certain requests are potentially “out of spec.”
After processing, the above control will be returned to the user interface module that may communicate the resulting workflow (lock accepted, accepted with extra info, lock subject to approval, denied) to the loan officer or broker.

Embodiments of the present disclosure may provide rules and procedures within pricing engines or origination systems. Embodiments of the present disclosure may eliminate errors and inconsistencies by ensuring that each borrower receives the correct pricing, based on their qualifications and loan parameters is an essential element of fair lending. Pricing disparities can arise from inadvertently under-pricing some borrowers and over-pricing others, if the errors happen to be correlated with a prohibited basis (such as race, ethnicity or gender). When the pricing process is not automated end-to-end, errors can arise both at the time rates are locked, and as loans are re-priced or re-locked due to changing circumstances prior to closing. Pricing engines eliminate the need for paper rate sheets, manual pricing calculations, and the need to manually check and re-check for adherence to pricing policies and applicable regulations each time a change occurs. Automation ensures that, for example, no loan-level pricing adjustments are missed or incorrectly applied and any available pricing premiums are handled consistently with the lender's pricing policies (e.g., either consistently retained by the company or consistently rebated to the borrower to the extent possible). Automation of the pricing process also may ensure that inadvertent errors or policy violations are flagged and addressed prior to closing.

Embodiments of the present disclosure may enforce pricing policies. Policies governing pricing discretion and other elements of pricing only work effectively if controls exist to enforce them. Workflow built into a pricing engine can be used to flag lock requests that exceed an originator's or branch manager's authority, force the input of appropriate justifications for concessions or exceptions, and automatically route the request to the appropriate manager or executive for approval. Further, the system workflow can generate a “data trail” that can be used to generate reporting to executive and compliance management regarding discretionary pricing. Such reporting can help to ensure that the cumulative frequencies and amounts of concessions or exceptions stay within established tolerances.

Embodiments of the present disclosure also may assist with compliance with anti-steering regulations. Automation according to embodiments of the present disclosure may allow the loan originator to be presented systematically with the set of viable loan program and pricing options available for each borrower's situation. This not only may create efficiencies for the originator, but also may reduce reliance on the originator's ability to identify all possible options and helps avoid situations in which latent biases may cause an originator to “steer” borrowers to particular products—either on a prohibited basis, or simply to enhance profits. Data on the options available or considered, and the rationale for the ultimate product selected, can be stored and can be produced to regulatory examiners as needed to defend against potential steering concerns.

Embodiments of the present disclosure also may allow better documentation of pricing decisions. Workflow steps can be built in to guide the originator through various process and compliance checklists, and to prompt the originator or other staff to input explanations for pricing decisions or changes along the way. If concerns about statistical pricing disparities should arise later, such documentation can help to justify the pricing of each loan to regulatory examiners, and to determine whether or not pricing differences are the result of business-justified decisions. Embodiments of the present disclosure also may retain complete and accurate data. Data input controls and validation checks can be automated to reduce errors in data capture, which otherwise could lead to pricing errors and an inability to explain pricing disparities on a statistical basis. Pricing engine systems can store every data element and every pricing adjustment that went into pricing each loan. Further, as the cost of data storage has declined, it has become possible also to store data on all available programs and pricing that were available at any point of time in the past, which can help in defending against claims of steering.

Embodiments of the present disclosure may demonstrate controls to regulatory examiners. Aside from helping to enforce compliance, an automated system of pricing controls can provide the means to easily demonstrate the control environment to regulatory examiners, who are interested in understanding the workings of a lender's “Compliance Management System.”

More and more, originators are starting to treat the production of a loan as a true manufacturing process, which it ultimately is. In many industries, the principles of Total Quality Management (TQM) have become a key to survival in a world less and less tolerant of defects. Slowly, in the loan origination process, the idea of a measurably correct process yielding a quality product is gaining a foothold, as it did in manufacturing industries several decades ago. If a quality (as in meeting the specification) process is put in place and the process may be measured during the “manufacturing” steps, the outcome should also meet the specification(s). In mortgage terms, if “compliant” (the specification) mortgages (or mortgages in a “compliant” way) are to be produced, then a process should be laid out that will produce that (the manufacturing steps), and whether what is actually happening should be measured to ensure that it matches the process that has been defined.

Apart from a few discretionary steps, the pricing of a loan can be a controlled and precise process. When the process is fully automated, which it rarely is, controls can be put in place to ensure and document compliance with both internal policies and regulatory requirements. It is in the discretionary steps, mostly having to do with borrowers' choices and intentions, where more monitoring is needed.

In the past, fair lending monitoring has been done ex post facto, leaving the lender with a set of potential compliance issues in either the latter stages of the origination process or after closing the loan. For example, disparities in average pricing between minority and non-minority race/ethnicity groups typically become evident only well after loans have closed and loan data has been aggregated for analysis—which may occur several months or longer after the loans were originated. At that point, correction of the process becomes difficult and costly even if no legal or enforcement action has (yet) sprouted from the issues.

The inherent challenge in implementing real-time monitoring in the context of fair lending is that the risk of discriminatory pricing disparities is typically measured based on the cumulative effects of pricing decisions on different demographic groups, and is typically measured based on an after-the-fact statistical analysis of hundreds or thousands of closed loans. Further, evaluating whether pricing disparities exist requires accounting for the many non-discriminatory credit- and product-based loan-level pricing adjustments (using a statistical regression analysis), which may create a superficial appearance of pricing disparities. Nevertheless, disparities accumulate in real time, loan by loan, so only a real-time loan-by-loan monitoring and control process can truly get to the heart of the matter. Real-time monitoring systems according to embodiments of the present disclosure may measure the effect of a single loan on the statistical aggregation of the resulting population (all loans). This is a difficult problem because of several aspects: first, loan rates and prices can be different because of borrowers' financial situations and choices, next, different markets or branch locations have different competitive landscapes and therefore different rates. A different rate does not necessarily indicate a fair lending issue. So, to be efficient and useful, the system according to embodiments of the present disclosure should properly compare rates as they are locked, and clearly flag outliers for review, preferably using a real-time visual presentation of the lock being contemplated in the context of other locks already made, accompanied by tools to highlight and halt potentially policy-violating choices.

The effects of choices made by borrowers (some people want to receive rebates to put towards closing costs and therefore select higher rates, others want to pay origination points to lower the rate) and the effects of different credit profiles (i.e. taking out the effects of lower FICO scores or other), when properly adjusted for can make the resulting rates comparable. At that point, the outliers would only reflect rate choices not dictated by “normal” rate-price dependencies as they are defined in the guidelines for the lending products. The “choices” that produce outliers after that interpretation are the ones that should be monitored very carefully in a Fair Lending context. When outliers are timely corrected or do not occur, the resulting aggregation of the information will eventually yield the right averages reflecting the correct implementation of the intended “compliant” workflow. In addition to reducing the potential for unjustified pricing disparities and increasing operational efficiency, this TQM-based approach to the pricing process provides the lender a way to demonstrate to examiners that an effective process is in place for early detection and correction of fair lending issues. Real-time monitoring may not replace the mandatory compliance reporting, but it may allow early detection of problems that could cause compliance issues when those reports are produced.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system for early fair lending violation detection, the system comprising:
a computerized mechanism that computes the price-rate-function for one or more mortgage products over a specified lock period;
one or more WebBots, wherein, under the control of a scheduler-coordinator module, the one or more WebBots navigate websites to retrieve pricing and eligibility of one or more mortgage products offered by outlets;
a price extraction module that interprets the pricing and eligibility of the mortgage products offered by outlets to form and then load price-rate grids into the product and pricing engine; and
a lock intercept module that uses the price-rate-function computed by the computerized mechanism to identify one or more actions to be taken,
wherein the computerized mechanism, the one or more WebBots, the price extraction module, and the lock intercept module communicate with each other over one or more communication networks.

2. The system of claim 1 wherein the computerized mechanism is a product and pricing engine.

3. The system of claim 1 wherein the computerized mechanism is a Bloomberg terminal.

4. The system of claim 1 wherein one of the one or more WebBots downloads government-published APOR data.

5. The system of claim 1 wherein the one or more actions to be taken by the lock intercept module are selected from the group comprising:
trigger the addition of a question to a compliance checklist to be answered before a lock request can be completed; set flag to temporarily halt a lock request and add it to an exception queue for further processing; set flag to temporarily halt the lock request and add it to an exception queue for escalation; set flag to temporarily halt the lock request and add it to an exception queue for escalation and sign off; set flag to temporarily halt the lock request and add it to an exception queue for sign off; deny the lock request; and set flags used by an alarm module to provide an alert that a lock request is out of spec.

6. The system of claim 1 further comprising:
a user interface module that communicates a resulting workflow to a loan officer.

7. The system of claim 6 wherein the resulting workflow is selected from the group comprising:
lock accepted, lock accepted with extra information, lock subject to approval, lock subject to approval through escalation, and lock denied.

8. The system of claim 1 wherein the one or more communication networks are selected from the group comprising:
Internet, Intranet, radio frequency, Bluetooth, infrared, USB, LAN, wireless LAN (WiLAN), worldwide interoperability for microwave access (WiMAX), WiFi, ultra-wide band (UWB), Wibree techniques, wide band code division multiple access (W-CDMA), CDMA2000, global system for mobile communications (GSM), general packet radio service (GPRS), long term evolution (LTE), WLAN, WiMAX, digital subscriber line (DSL), cable modems, Ethernet, and combinations of the same.

9. A method for processing a loan intercept with a lock intercept module, the method comprising:
receiving an alert of a pending lock request; and
processing the loan intercept by using a loan profile and selected product information provided by a product and pricing engine over a communication link to determine actions to be taken, wherein the actions to be taken are selected from the group comprising:
triggering the addition of a question to a compliance checklist to be answered before a lock request can be completed; setting a flag to temporarily halt a lock request and add it to an exception queue for further processing; setting flag to temporarily halt the lock request and add it to an exception queue for escalation; setting flag to temporarily halt the lock request and add it to an exception queue for escalation and sign off; setting flag to temporarily halt the lock request and add it to an exception queue for sign off; denying the lock request; and setting one or more flags to be used by an alarm module to provide an alert that a lock request is out of spec,
wherein the steps are performed using one or more communication networks.

10. The method of claim 9, wherein processing the loan intercept further comprises:
calculating the relative equivalent distance to APOR (RED) using the equivalent rate and the equivalent APR based on engine-generated profile-based loan-level price adjustments and a selected rate/price.

11. The method of claim 9, wherein processing the loan intercept further comprises:
using a set of predefined and user-defined filters to identify to what filter the lock request belongs; and
using the identified filter, comparing the RED to an aggregated RED for the identified filter.

12. The method of claim 11, where the predefined and user-defined filters are a combination of loan product, geographic, borrower and property parameters used to group loans with similar rate/price outcomes when fed with equivalent profiles.

13. The method of claim 11, wherein when the loan profile includes ethnicity, comparing the RED to ethnicity-based aggregates.

14. The method of claim 9 wherein when the action to be taken is triggering the addition of a question to a compliance checklist to be answered before a lock request can be completed, the method further comprises:
storing the answer to the question with the loan information for later reporting.

15. The method of claim 9 further comprising:
after processing, communicating a resulting workflow to a loan officer.

16. The method of claim 15, wherein the resulting workflow is selected from the group comprising:
lock accepted, lock accepted with extra information, lock subject to approval, lock subject to approval through escalation, and lock denied.

17. The method of claim 9 wherein the one or more communication networks are selected from the group comprising:
Internet, Intranet, radio frequency, Bluetooth, infrared, USB, LAN, wireless LAN (WiLAN), worldwide interoperability for microwave access (WiMAX), WiFi, ultra-wide band (UWB), Wibree techniques, wide band code division multiple access (W-CDMA), CDMA2000, global system for mobile communications (GSM), general packet radio service (GPRS), long term evolution (LTE), WLAN, WiMAX, digital subscriber line (DSL), cable modems, Ethernet, and combinations of the same.

18. A method for early detection of fair lending violations, the method comprising:
utilizing a lock intercept module, performing a lock intercept process to compute whether a requested lock is acceptable to a lender using the desired/existing equivalent for a group and at least one parameter selected from the group comprising:
relative distance to APOR, relative equivalent distance to APOR, quoted rate, price and APR;
using the output of the lock intercept process to perform one of the following actions: continue the automated lock process, interrupt the process by requiring further disclosure and explanation of the borrower/loan officer reached decisions; and interrupt the process by putting the lock in a hold queue for approval by one or more levels of compliance managers; and
using the output of the lock intercept process to produce a notification about the current state of compliance, wherein the notification is provided over one or more communication networks.

19. The method of claim 18 wherein the notification is a visual or auditory alert.

20. The method of claim 18 wherein the notification is performed by an alarm module.
